(19) United States
(12) Patent Application Publication
(10) Pub. No.: US 2026/0024246 A1
(43) Pub. Date: Jan. 22, 2026

(54) DRAWING METHOD AND ELECTRONIC DEVICE FOR PERFORMING SAME

(71) Applicant: Korea Advanced Institute of Science and Technology, Daejeon (KR)

(72) Inventors: Seok-Hyung BAE, Daejeon (KR); Seungjun LEE, Daejeon (KR); Joon Hyub LEE, Daejeon (KR)

(21) Appl. No.: 18/852,543

(22) PCT Filed: Mar. 29, 2023
(86) PCT No.: PCT/KR2023/004161

§ 371 Date: Sep. 30, 2024

(30) Foreign Application Priority Data
Mar. 28, 2023 (KR) 10-2023-0040292
Mar. 29, 2023 (KR) 10-2022-0038950

(51) Int. Cl. G06T 11/20; G06F 3/044; G06F 3/04883; G09B 11/04

(52) U.S. Cl. CPC G06T 11/203; G06F 3/044; G06F 3/04883; G09B 11/04

(57) ABSTRACT

A drawing method and an electronic device for performing the method are disclosed. A drawing method according to an embodiment of the present invention may comprise the steps of: providing a feature line included in a drawing object in a first grid on the basis of the drawing object; providing first feature points corresponding to the feature line; providing second feature points corresponding to the first feature points in a second grid corresponding to the first grid; receiving an input line that is along the second feature points; and determining whether the input line corresponds to the feature line.

### TECHNICAL FIELD

The following description relates to a drawing method and an electronic device for performing the method.

### BACKGROUND ART

To draw well, the ability to accurately observe and draw objects as they appear, which refers to perceptual drawing, and the ability to draw imaginary objects in perspective, which refers to perspective drawing, are essential.

To acquire those abilities for perceptual drawing and perspective drawing, a proper understanding of perceptual drawing and perspective drawing skills and repeated training are required.

### DISCLOSURE OF THE INVENTION

### Technical Goals

Various embodiments provide a drawing method that may provide a systematic drawing training process for training in skills essential to drawing training and allow a user to perform the training process efficiently using auxiliary lines and auxiliary points when drawing a drawing object for drawing training, and an electronic device for performing the method.

### Technical Solutions

A drawing method according to various embodiments may include providing a character line included in a drawing object in a first grid based on the drawing object, providing a first character point corresponding to the character line, providing a second character point corresponding to the first character point in a second grid corresponding to the first grid, receiving an input line along the second character point, and determining whether the input line corresponds to the character line.

The providing of the second character point may include displaying first auxiliary lines based on the first character point, determining first auxiliary points in the first grid based on the first auxiliary lines, displaying second auxiliary points corresponding to the first auxiliary points in the second grid, displaying second auxiliary lines related to the second character point based on the second auxiliary points, and determining the second character point based on the second auxiliary lines.

The providing of the second character point may include displaying first auxiliary lines at vertices of a region including the first character point in the first grid, determining a first auxiliary point in the first grid based on the first auxiliary lines, displaying a second auxiliary point corresponding to the first auxiliary point in the second grid, and displaying second auxiliary lines related to the second character point based on the second auxiliary point.

The first grid may be displayed on a plane, and the second grid may be displayed on a floor plane and a plane perpendicular to the floor plane in a three-dimensional coordinate system.

The providing of the second character point may include displaying, on the floor plane, a second character point corresponding to a first character point that is based on a perspective view of the drawing object, and displaying, on the plane perpendicular to the floor plane, a second character point corresponding to a first character point that is based on a side view of the drawing object.

The drawing method may further include displaying the input line corresponding to the character line on the floor plane and the plane perpendicular to the floor plane, and providing third character points that correspond to the input line displayed on the floor plane and the input line displayed on the plane perpendicular to the floor plane and are related to a shape of the drawing object.

In claim 1, the providing of the character line may include providing a first character line that is based on a perspective view of the drawing object and a second character line that is based on a side view of the drawing object, and the first character line and the second character line may correspond to a shape of the drawing object.

The drawing method may further include displaying the input line corresponding to the character line when the input line corresponds to the character line.

The determining of the first auxiliary points may include displaying a second input line corresponding to the first auxiliary lines based on a straightness of the second input line, a gradient of the second input line, and whether the second input line passes through the first character point, and the determining of the second character point may include displaying a third input line corresponding to the second auxiliary lines based on a straightness of the third input line, a gradient of the third input line, and whether the third input line passes through the second auxiliary points.

A drawing method according to various embodiments may include providing a character line included in a drawing object in a first grid displayed as a plane based on the drawing object, providing a first character point corresponding to the character line, providing a second character point corresponding to the first character point in a second grid, receiving a first input line along the second character point, determining whether the first input line corresponds to the character line, providing a third character point corresponding to the second character point in a third grid, receiving a second input line along the third character point, and determining whether the second input line corresponds to the character line, wherein the second grid may be displayed as a plane corresponding to the first grid, and the third grid may be displayed on a floor plane and a plane perpendicular to the floor plane of a three-dimensional coordinate system corresponding to the first grid.

The providing of the second character point may include displaying first auxiliary lines based on the first character point, determining first auxiliary points in the first grid based on the first auxiliary lines, displaying second auxiliary points corresponding to the first auxiliary points in the second grid, and displaying second auxiliary lines related to the second character point based on the second auxiliary points.

The providing of the third character point may include displaying a first input line corresponding to the character line in the first grid, displaying first auxiliary lines at vertices of a region including the second character point in the first grid, determining a first auxiliary point in the first grid based on the first auxiliary lines, displaying a second auxiliary point corresponding to the first auxiliary point in the third grid, and displaying second auxiliary lines related to the third character point based on the second auxiliary point.

The drawing method may further include displaying second input lines corresponding to the character line on the floor plane and the plane perpendicular to the floor plane, determining a first reference point on the second input line displayed on the plane perpendicular to the floor plane, providing first auxiliary lines based on the first reference point, determining a second reference point corresponding to the first reference point on the second input line displayed on the floor plane using the first auxiliary lines, providing second auxiliary lines based on the second reference point, and providing a fourth character point corresponding to a shape of the drawing object using the second auxiliary lines.

The drawing method may further include determining whether a third input line received along the fourth character point corresponds to the shape of the drawing object, and displaying the third input line corresponding to the shape of the drawing object and a shade corresponding to the shape of the drawing object in the third grid.

An electronic device according to various embodiments may include a processor, wherein the processor may be configured to provide a character line included in a drawing object in a first grid based on the drawing object, provide a first character point corresponding to the character line, provide a second character point corresponding to the first character point in a second grid corresponding to the first grid, receive an input line along the second character point, and determine whether the input line corresponds to the character line.

The processor may be configured to display first auxiliary lines based on the first character point, determine first auxiliary points in the first grid based on the first auxiliary lines, display second auxiliary points corresponding to the first auxiliary points in the second grid, and display second auxiliary lines related to the second character point based on the second auxiliary points.

The processor may be configured to display first auxiliary lines at vertices of a region including the first character point in the first grid, determine a first auxiliary point in the first grid based on the first auxiliary lines, display a second auxiliary point corresponding to the first auxiliary point in the second grid, and display second auxiliary lines related to the second character point based on the second auxiliary point.

The first grid may be displayed on a plane, and the second grid may be displayed on a floor plane and a plane perpendicular to the floor plane in a three-dimensional coordinate system.

The processor may be configured to display, on the floor plane, a second character point corresponding to a first character point that is based on a perspective view of the drawing object, and display, on the plane perpendicular to the floor plane, a second character point corresponding to a first character point that is based on a side view of the drawing object.

The processor may be configured to display the input line corresponding to the character line on the floor plane and the plane perpendicular to the floor plane, and provide third character points that correspond to the input line displayed on the floor plane and the input line displayed on the plane perpendicular to the floor plane and are related to a shape of the drawing object.

The processor may be configured to provide a first character line that is based on a perspective view of the drawing object and a second character line that is based on a side view of the drawing object, and the first character line and the second character line may correspond to a shape of the drawing object.

### Effects of the Invention

According to an embodiment of the present disclosure, a user may efficiently perform drawing training using auxiliary lines and auxiliary points provided while drawing an object, which may improve training efficiency.

### BRIEF DESCRIPTION OF DRAWINGS

FIG. 1 is a diagram illustrating operations provided by an electronic device according to various embodiments.

FIGS. 2A and 2B are diagrams illustrating a drawing object according to various embodiments.

FIGS. 3A and 3B are diagrams illustrating an operation of providing a drawing region expressed as a plane by an electronic device according to various embodiments.

FIGS. 4A to 4F are diagrams illustrating an operation of providing character points in a drawing region by an electronic device according to various embodiments.

FIGS. 5A and 5B are diagrams illustrating an operation of providing a drawing region expressed as a floor plane and a plane perpendicular to the floor plane in three-dimensional (3D) coordinates by an electronic device according to various embodiments.

FIGS. 6A to 6H are diagrams illustrating an operation of providing character points in a drawing region expressed as a floor plane and a plane perpendicular to the floor plane in 3D coordinates by an electronic device according to various embodiments.

FIGS. 7A and 7B are diagrams illustrating an operation of providing auxiliary lines and auxiliary points by an electronic device according to various embodiments.

FIGS. 8A to 8E are diagrams illustrating an operation of providing auxiliary lines and auxiliary points by an electronic device according to various embodiments.

FIGS. 9A and 9B are diagrams illustrating an operation of displaying input lines in a drawing region in response to inputs from a user by an electronic device according to various embodiments and the electronic device according to various embodiments.

FIG. 10 is a flowchart illustrating a drawing method according to various embodiments.

FIG. 11 is a flowchart illustrating an operation of determining a second character point by an electronic device according to various embodiments.

FIG. 12 is a flowchart illustrating an operation of determining a second character point by an electronic device according to various embodiments.

FIG. 13 is a flowchart illustrating an operation of displaying second input lines in a second grid by an electronic device according to various embodiments.

FIG. 14 is a flowchart illustrating a drawing method according to various embodiments.

FIG. 15 is a flowchart illustrating an operation of providing fourth character points by an electronic device according to various embodiments.

### BEST MODE FOR CARRYING OUT THE INVENTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

To improve perceptual drawing and perspective drawing abilities, training in various drawing skills is needed. For example, the drawing skills include (1) selecting a planar grid in which the proportion of an object can be effectively observed, (2) observing the proportion of an object using the planar grid and drawing the object identically, (3) observing the negative space of the planar grid and drawing the object identically, (4) moving one point on the planar grid to the same position on another planar grid, (5) drawing a straight line or a curve by connecting points, (6) drawing a straight line in perspective while imagining the position of a vanishing point, (7) selecting a three-dimensional (3D) grid in which a desired object can be effectively expressed, (8) moving one point on the planar grid to the same position on the 3D grid, (9) transferring a curve on the planar grid to the 3D grid, and (10) drawing 3D curves with symmetry by combining the curves on the central plane and the floor plane of the 3D grid.

According to various embodiments, an electronic device may display auxiliary lines for assisting a user with drawing, on a character point or auxiliary point in a grid where a drawing object is displayed or a grid corresponding to a drawing region, thereby assisting the user with drawing training. The user may efficiently perform drawing training using the auxiliary lines displayed on the character point or auxiliary point provided by the electronic device.

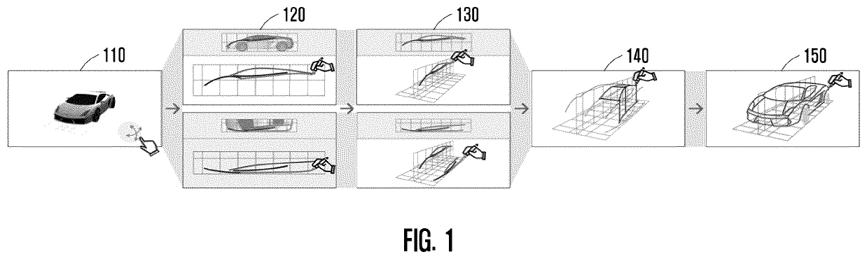

FIG. 1 is a diagram illustrating operations provided by an electronic device according to various embodiments.

Referring to FIG. 1, the electronic device may display a drawing object in operation 110. For example, the electronic device may include a display, and display the drawing object on the display. The display may display the drawing object, character lines, character points, auxiliary points, auxiliary lines, input lines, grids, and the like described below. The display may receive an input, such as a touch, from the user, or an input provided using a capacitive/electromagnetic resonance input device.

The electronic device may display the drawing object on the display while adjusting the position and angle of the drawing object and enlarging/reducing the drawing object, according to the input from the user in operation 110. The electronic device may display the drawing object in a grid. For example, the electronic device may display the drawing object to be superimposed on a grid expressed as a floor surface and a grid expressed as a plane perpendicular to the floor plane in a 3D coordinate system. The electronic device may determine the shape (e.g., composition, position, etc.) of the desired drawing object according to the input from the user.

For example, operation 110 may be called the observation stage.

The electronic device may display character lines of the drawing object in a first grid in operation 120. For example, the character lines may be lines for drawing the drawing object. The character lines may be displayed in different colors. When the user selects a specific character line, the electronic device may display the selected character line darker and hide the remaining character lines or display the remaining character lines lighter.

The first grid may be determined based on the drawing object. The first grid may be determined to be a grid divided into a plurality of regions based on the size, shape, and characteristics of the drawing object. The size of each of the plurality of regions may be determined based on the size, shape, and characteristics of the drawing object.

The electronic device may display a second grid. For example, the second grid may correspond to the first grid. The second grid may be different from the first grid in total width and total height. The size of each of a plurality of regions of the second grid may correspond to the size of each of the plurality of regions of the first grid. For example, when the first grid is determined to be a 3×2 square with a side length of “1”, the electronic device may determine to be a 3×2 square with a side length of “2”. For example, the electronic device may display the first grid on the upper side of the display and the second grid on the lower side of the display.

The electronic device may provide character points in the second grid so that the user may draw character lines of the first grid in the second grid, and display lines corresponding to the character lines among input lines.

Operation 120 may be called the 2D plane drawing stage.

The electronic device may provide character lines of the drawing object in the first grid expressed as a plane, in operation 130. The electronic device may operate substantially in the same manner as in operation 120 of providing character lines in the first grid.

For example, the electronic device may provide the input lines that are input from the user in operation 120, in operation 130. The electronic device may sequentially provide the input lines that are input from the user in operation 120 in the first grid, or provide a selected input line in response to a selection of the user in operation 130.

The electronic device may include a grid (e.g., a third grid) including a floor plane and a plane perpendicular to the floor plane in a 3D coordinate system. The size of each of a plurality of regions of the floor plane and the vertical plane (the plane perpendicular to the floor plane) of the third grid may correspond to the size of each of the plurality of regions of the first grid.

For example, when a perspective view of the drawing object is displayed in the first grid, the electronic device may display character points, auxiliary points, and auxiliary lines on the floor plane of the third grid, and display input lines. When a perspective view of the drawing object is displayed in the first grid, the user may draw on the floor plane of the third grid.

For example, when a side view of the drawing object is displayed in the first grid, the electronic device may display character points, auxiliary points, and auxiliary lines on the vertical plane of the third grid, and display input lines. When a side view of the drawing object is displayed in the first grid, the user may draw on the vertical plane of the third grid.

Operation 130 may be called the 3D plane drawing stage.

The electronic device may display input lines in the third grid and provide auxiliary points and auxiliary lines to determine third character points in operation 140. In operation 140, the user may expand the input lines of the planes (e.g., the floor plane and the vertical plane of the third grid) to correspond to a 3D drawing object. The user may input the input lines corresponding to the shape of the drawing object, using the input lines of the planes. For the user to input the input lines corresponding to the shape of the drawing object, the auxiliary lines, the auxiliary points, and the third character points may be displayed on the display.

For example, the electronic device may provide the input lines that are input from the user in operation 130, in operation 140. The electronic device may sequentially provide the input lines that are input from the user in operation 130 in the first grid, or provide a selected input line in response to a selection of the user in operation 140.

Operation 140 may be called the 3D space drawing stage.

The electronic device may receive input lines according to inputs from the user and display the input lines in operation 150. The electronic device may display an auxiliary object to display the shape, appearance, and characteristics of the drawing object. The auxiliary object may be displayed in the third grid with a dark shade to correspond to the rough shape, appearance, and characteristics of the drawing object.

Operation 150 may be called the free drawing stage.

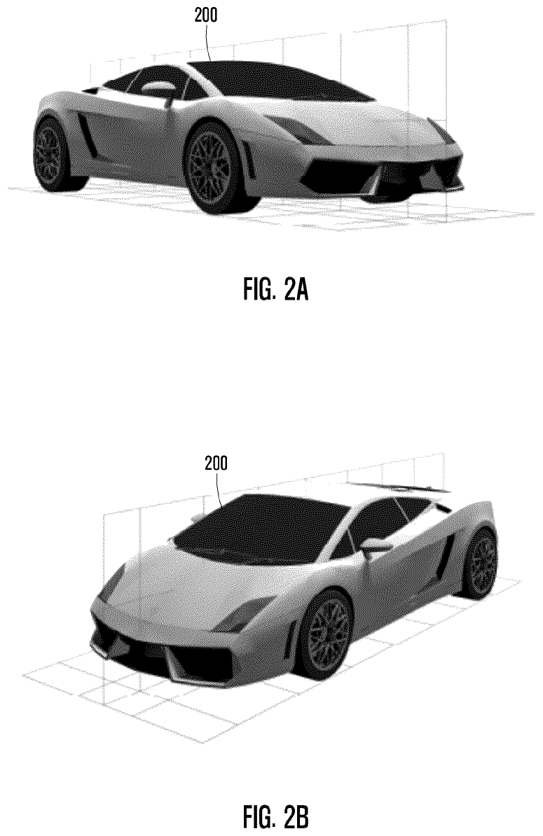

FIGS. 2A and 2B are diagrams illustrating a drawing object according to various embodiments.

FIGS. 2A and 2B are diagrams illustrating operation 110 of the electronic device described with reference to FIG. 1. The electronic device may display a drawing object to be superimposed on a grid expressed as a floor plane and a plane perpendicular to the floor plane in a 3D coordinate system. The floor plane of the grid may be determined based on the lowest point of the drawing object. The plane perpendicular to the floor plane of the grid may be positioned at the (horizontal axis) center of the drawing object.

The electronic device may display the 3D drawing object by rotating or enlarging/reducing the 3D drawing object according to an input from the user.

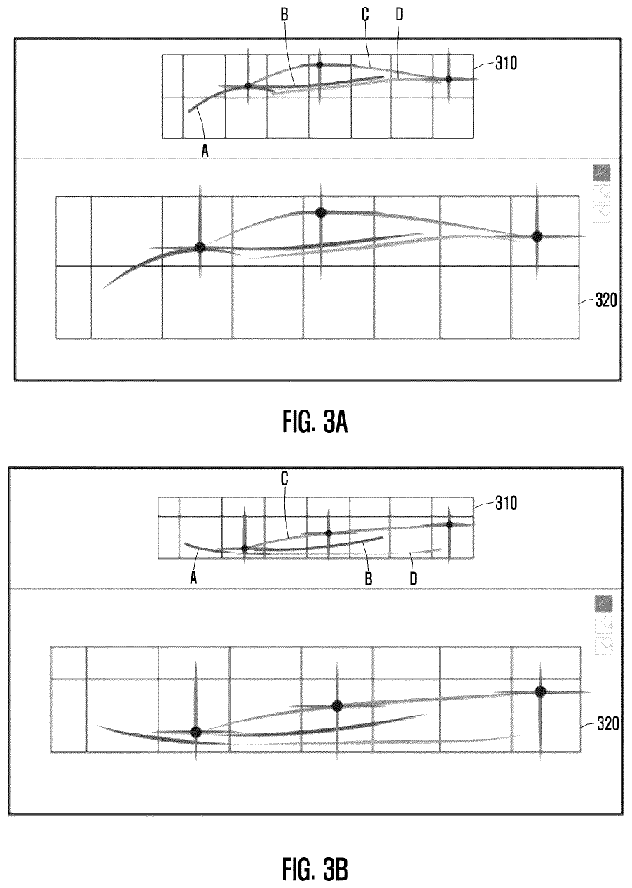

FIGS. 3A and 3B are diagrams illustrating an operation of providing a drawing region expressed as a plane by an electronic device according to various embodiments.

FIGS. 3A and 3B are diagrams illustrating operation 120 of the electronic device described with reference to FIG. 1. FIG. 3A is an example of displaying a side view of a drawing object in a first grid, and FIG. 3B is an example of displaying a perspective view of the drawing object in the first grid. A user may draw input lines in a second grid by referring to character lines of the drawing object displayed in the first grid. The electronic device may provide character points, auxiliary points, and auxiliary lines so that the user may draw input lines corresponding to the character lines in the second grid.

The electronic device may display the first grid on the upper side of a display, and the second grid on the lower side of the display. The size of each of the regions of the second grid may correspond to the size of each of the region of the first grid. The regions of the second grid may be different in size, but the size ratio of the regions of the second grid may correspond to the size ratio of the regions of the first grid.

The character lines of the drawing object displayed in the first grid of FIG. 3A and the character lines of the drawing object displayed in the first grid of FIG. 3B may correspond to the shape of the drawing object. For example, a character line A, a character line B, a character line C, and a character line D of FIG. 3A may correspond to a character line A, a character line B, a character line C, and a character line D of FIG. 3B, respectively. A predetermined part of the drawing object (e.g., the roof of a car) may have the shape of the character line A of FIG. 3A when viewed from the side, and the part may have the shape of the character line A of FIG. 3B when viewed from the side.

The electronic device may display the character lines in different colors. The electronic device may display input lines corresponding to the character lines in the colors of the character lines.

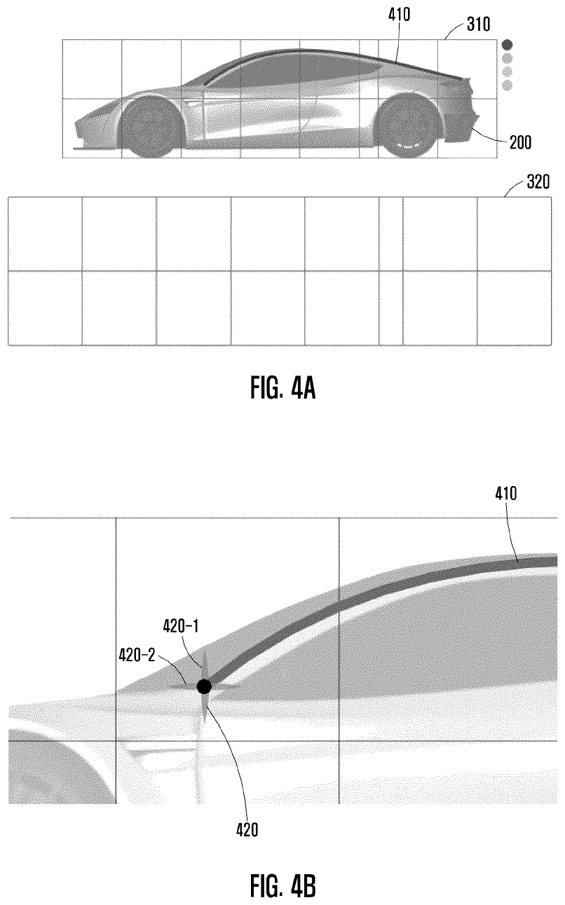

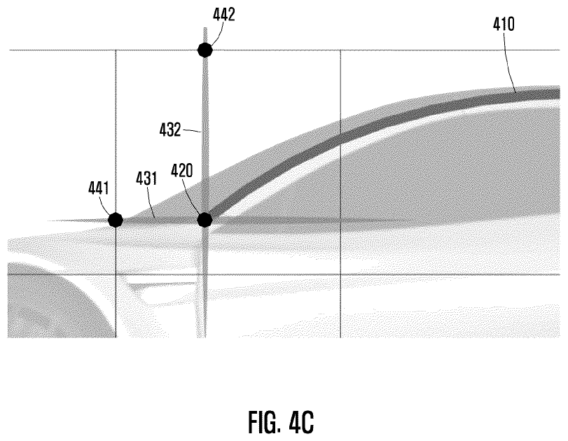

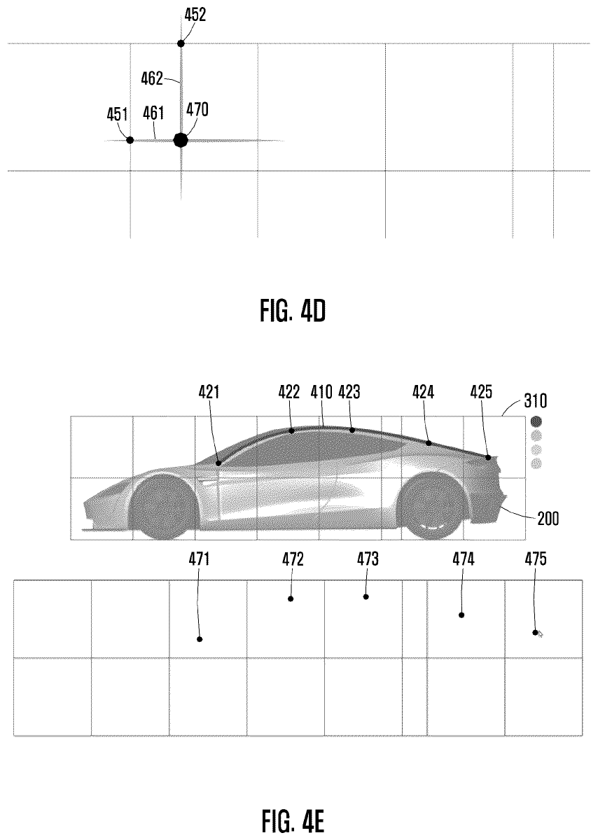

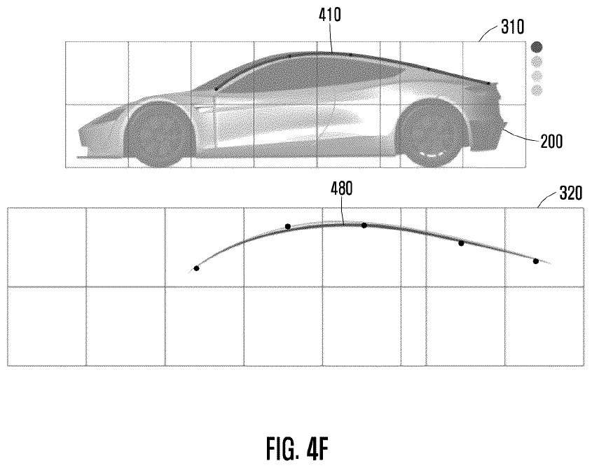

FIGS. 4A to 4F are diagrams illustrating an operation of providing character points in a drawing region by an electronic device according to various embodiments. For example, the drawing region may represent a first grid 310 and/or a second grid 320.

As in FIG. 4A, the electronic device may display a character line 410 and a drawing object 200 in the first grid 310. The electronic device may display the second grid 320 corresponding to the first grid 310. FIG. 4A is an example in which the character line 410 is selected from among a plurality of character lines.

As in FIG. 4B, the electronic device may provide a first character point 420 based on the character line 410 of the first grid. For example, the electronic device may determine the first character point 420 on the character line 410 based on an input from a user. The electronic device may display the determined first character point 420 on a display.

For example, when the input from the user is received within a set distance from the character line 410, the electronic device may display the determined first character point 420 on the display. When the input from the user is received out of the set distance from the character line 410, the electronic device may display the point input from the user on the display for a set time (e.g., 1 second), and blur the point gradually after the set time.

The electronic device may display first auxiliary lines 420-1 and 420-2 (e.g., first auxiliary lines) based on the first character point 420. The first auxiliary lines 420-1 and 420-2 may be vertical/horizontal lines at the first character point 420.

For example, when the user selects the first character point 420, the electronic device may display the first auxiliary lines 420-1 and 420-2 on the display. When the input from the user is received within a set distance from the first character point 420, the electronic device may display the first auxiliary lines 420-1 and 420-2 on the display. When the input from the user is received out of the set distance from the first character point 420, the electronic device may display the point input from the user on the display for a set time (e.g., 1 second), and blur the point gradually after the set time.

The operation of displaying, by the electronic device, the first character point 420 or the first auxiliary lines 420-1 and 420-2 based on whether the input received from the user is within the set distance from the character line 410 or the first character point 420 may substantially identically apply to the operation of the electronic device performed according to an input from the user.

As in FIG. 4C, the electronic device may determine first auxiliary points 441 and 442 based on the first auxiliary lines 420-1 and 420-2. For example, the electronic device may determine the first auxiliary points 441 and 442 on the first grid 310. The electronic device may determine the first auxiliary points 441 and 442 on the boundary of a region of the first grid 310 including the first character point 420.

The electronic device may display auxiliary lines 431 and 432 based on the first auxiliary lines 420-1 and 420-2. For example, when the first auxiliary lines 420-1 and 420-2 are displayed at the character point 420 as in FIG. 4B, the user may input a horizontal line and a vertical line at the first character point 420. The electronic device may determine whether the horizontal line and the vertical line input by the user pass through the first character point 420, the straightness of the horizontal line and the vertical line, and the angles of the horizontal line and the vertical line. When the horizontal line and the vertical line input by the user satisfy set criteria, the horizontal line input by the user may be displayed as the auxiliary line 431, and the vertical line input by the user may be displayed as the auxiliary line 432.

As in FIG. 4D, the electronic device may display second auxiliary points 451 and 452 corresponding to the first auxiliary points 441 and 442 in the second grid 320. The region of the second grid 320 in which the second auxiliary points 451 and 452 are displayed may correspond to the region including the first character point 420 of the first grid 310.

The electronic device may display the second auxiliary points 451 and 452 in the second grid 320 based on an input from the user. For example, the electronic device may determine a position, in the second grid 320, corresponding to the first auxiliary point 441 of the first grid 310. When the point selected by the user through the display is within a set distance from the determined position in the second grid 320, the electronic device may display the second auxiliary point 451. The description of the second auxiliary point 451 may substantially identically apply to the second auxiliary point 452.

The electronic device may display second auxiliary lines based on the second auxiliary points 451 and 452. The second auxiliary lines may be lines for determining a second character point 470. The electronic device may display the second auxiliary lines at the second auxiliary points 451 and 452 substantially in the same manner as displaying the first auxiliary lines 420-1 and 420-2 of FIG. 4B. For example, the electronic device may display a second horizontal auxiliary line at the second auxiliary point 451 and display a second vertical auxiliary line at the second auxiliary point 452.

Similar to the operation of the electronic device of FIG. 4C, the electronic device may display the horizontal line passing through the second auxiliary point 451 as an auxiliary line 461 based on an input from the user. The electronic device may display the vertical line passing through the second auxiliary point 452 as an auxiliary line 462 based on an input from the user. The electronic device may determine whether the auxiliary lines 461 and 462 satisfy set criteria, considering whether the auxiliary lines 461 and 462 pass through the auxiliary points 451 and 452, respectively, and the horizontality/verticality of the auxiliary lines 461 and 462.

The electronic device may determine the intersection point of the auxiliary line 461 and the auxiliary line 462 to be the second character point 470, and display the intersection point on the display. For example, when the intersection point of the auxiliary line 461 and the auxiliary line 462 is input from the user, the electronic device may determine the intersection point of the auxiliary line 461 and the auxiliary line 462 to be the second character point 470.

As in FIG. 4E, the electronic device may display first character points 421, 422, 423, 424, and 425 of the character line 410 displayed in the first grid 310 and the drawing object 200 in the first grid 310. The electronic device may display second character points 471, 472, 473, 474, and 475 corresponding to the first character points 421, 422, 423, 424, and 425 in the second grid 320. The second character points 471, 472, 473, 474, and 475 may be determined based on the first character points 421, 422, 423, 424, and 425, respectively, through the process shown in FIGS. 4A to 4D.

The electronic device may receive an input line from the user along the second character points 471, 472, 473, 474, and 475. The electronic device may determine whether the input line that is input from the user matches the character line 410. When the degree to which the input line matches the character line 410 satisfies a preset criterion, the electronic device may display an input line 480 corresponding to the character line 410 in the second grid 320, as in FIG. 4F. When the input line does not correspond to the character line 410 (if not satisfying the set criterion), the electronic device may hide the input line from the second grid 320.

The electronic device may display the input line not corresponding to the character line 410 on the display for a set time (e.g., 1 second) and blur the input line gradually after the set time to disappear from the display. The above description may substantially identically apply to the operation of the electronic device displaying an input line on the display based on whether a set condition is satisfied.

As in FIG. 4F, the electronic device may display the character line 410 and the drawing object 200 in the first grid 310, and display the input line 480 corresponding to the character line 310 in the second grid 320.

After displaying the input line 480 corresponding to the character line 310, the electronic device may hide the first auxiliary lines 420-1 and 420-2, the first auxiliary points 441 and 442, the auxiliary lines 431, 432, 461, and 462, the second auxiliary points 451 and 452, the second auxiliary lines, the first character points 470, 471, 472, 473, 474, and 475, and the second character points 480, 481, 482, 483, 484, and 485 from the display

Referring to FIGS. 4A to 4F, the electronic device may display auxiliary lines or auxiliary points on the display based on an input from the user. For example, when the user selects character points (e.g., the first character points 470, 471, 472, 473, 474, and 475 and the second character points 480, 481, 482, 483, 484, and 485), the electronic device may display auxiliary lines (e.g., the first auxiliary lines 420-1 and 420-2, the auxiliary lines 431, 432, 461, and 462, and the second auxiliary lines) on the display. For example, when the user selects auxiliary points (e.g., the first auxiliary points 441 and 442 and the second auxiliary points 451 and 452), the electronic device may display auxiliary lines on the display. As above, the electronic device may display points or lines for assistance in drawing on the display in response to an input from the user.

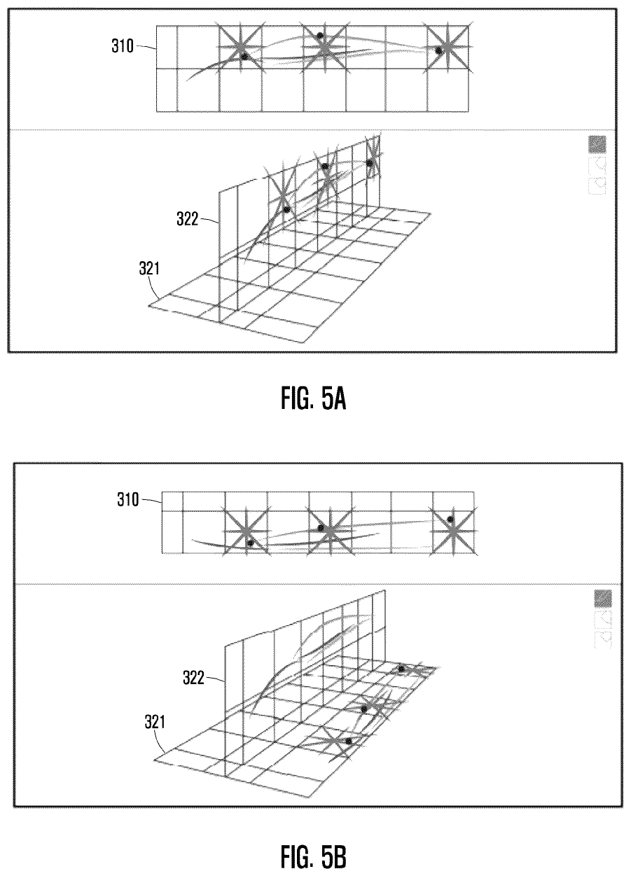

FIGS. 5A and 5B are diagrams illustrating an operation of providing a drawing region expressed as a floor plane and a plane perpendicular to the floor plane in three-dimensional (3D) coordinates by an electronic device according to various embodiments.

FIGS. 5A and 5B are diagrams illustrating operation 130 of the electronic device described with reference to FIG. 1. FIG. 5A is an example of displaying a side view of a drawing object in the first grid 310, and FIG. 5B is an example of displaying a perspective view of the drawing object in the first grid 310. A user may draw input lines in a second grid 321 and 332 by referring to character lines of the drawing object displayed in the first grid 310. The electronic device may provide character points, auxiliary points, and auxiliary lines so that the user may draw input lines corresponding to the character lines in the second grid 321 and 332.

Referring to FIGS. 5A and 5B, the electronic device may display the first grid 310 on a plane, and display the second grid 321 and 332 on a floor plane and a plane perpendicular to the floor plane in a 3D coordinate system. The second grid 321 may correspond to the floor plane in the 3D coordinate system, and the second grid 322 may correspond to the plane perpendicular to the floor plane in the 3D coordinate system.

When the perspective view of the drawing object is displayed in the first grid 310, the electronic device may display second character points corresponding to first character points of the drawing object in the second grid 321. The user may draw in the second grid 321.

When the side view of the drawing object is displayed in the first grid 310, the electronic device may display second character points corresponding to first character points of the drawing object in the second grid 322. The user may draw in the second grid 321.

FIGS. 5A and 5B are similar to the embodiment shown in FIGS. 3A and 3B except that the second grid 321 and 332 are expressed based on a 3D coordinate system. Therefore, the description provided with reference to FIGS. 3A and 3B may substantially identically apply to FIGS. 5A and 5B even if omitted from the description thereof.

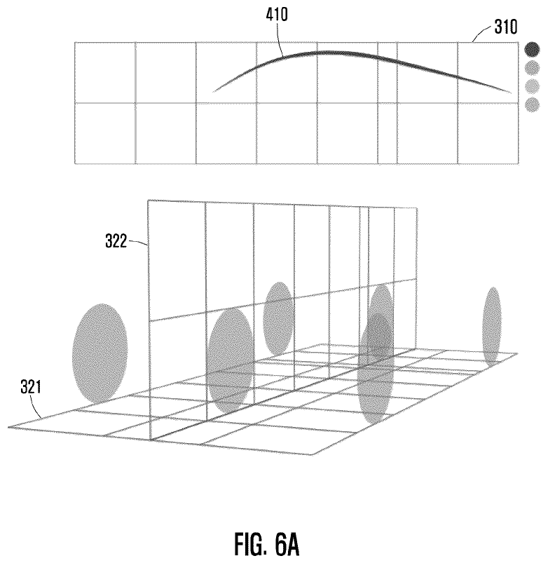

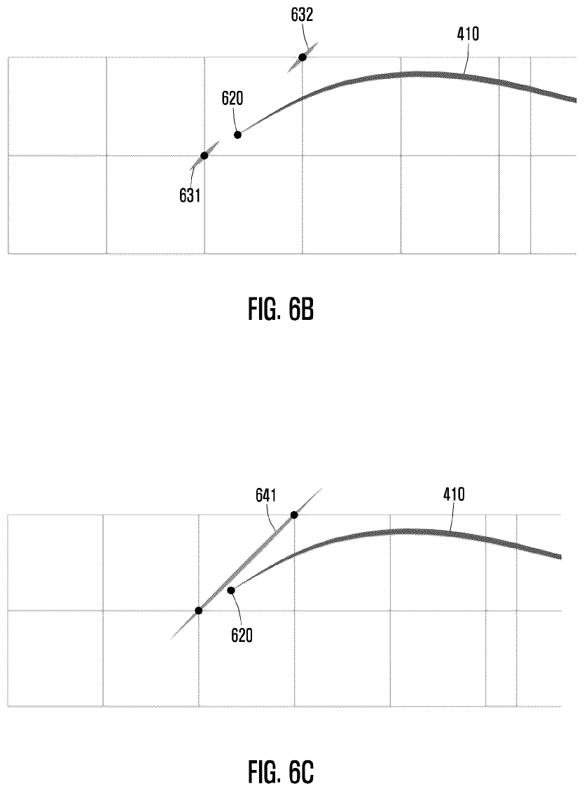

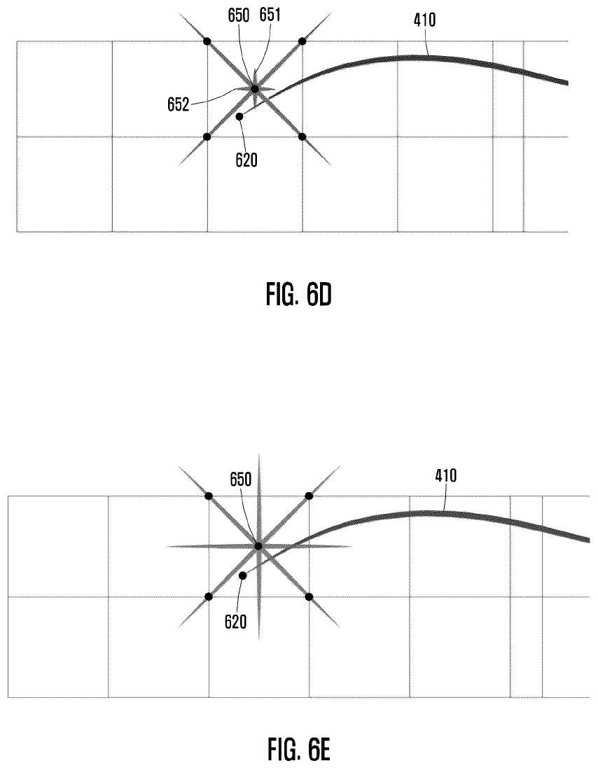

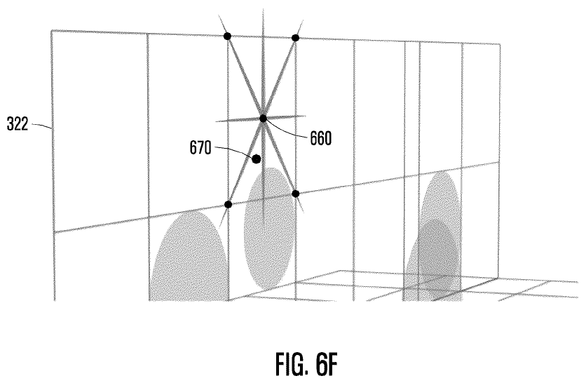

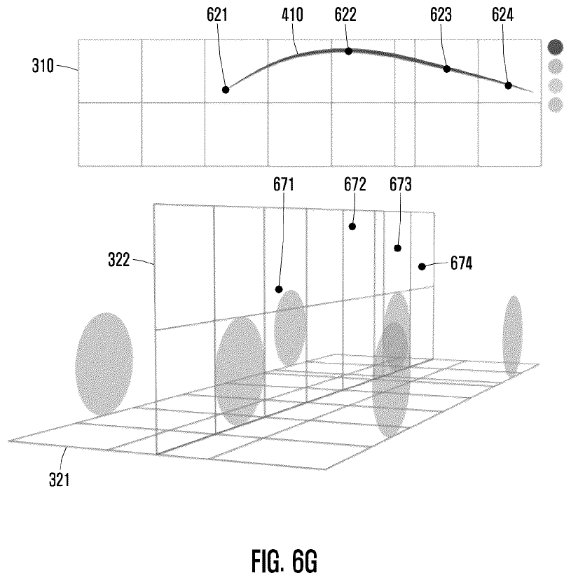

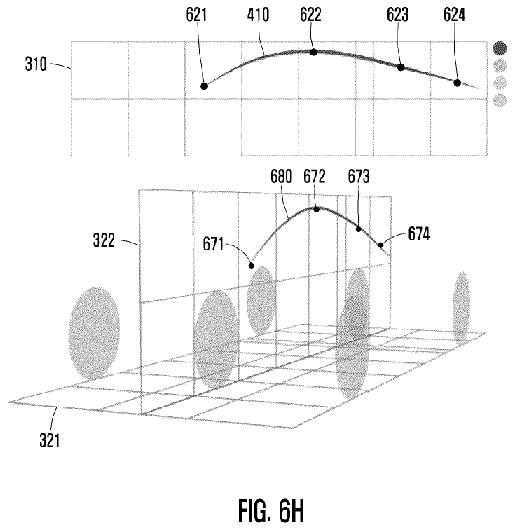

FIGS. 6A to 6H are diagrams illustrating an operation of providing character points in a drawing region expressed as a floor plane and a plane perpendicular to the floor plane in 3D coordinates by an electronic device according to various embodiments. For example, the drawing region may be the first grid 310 and/or the second grid 321 and 332.

FIGS. 6A to 6H below show an example of providing the character line 410 in the first grid 310 by the electronic device. FIGS. 6A to 6H below may substantially identically apply to a case where the electronic device provides the input line 480 corresponding to the character line 410 in the first grid 310.

As in FIG. 6A, the electronic device may display the character line 410 in the first grid 310. The electronic device may display the second grid 321 and 332 corresponding to the first grid 310. FIG. 6A is an example in which the character line 410 is selected from among a plurality of character lines.

As in FIG. 6B, the electronic device may provide a first character point 620 based on the character line 410 of the first grid. For example, the electronic device may determine the first character point 620 on the character line 410 based on an input from a user. The electronic device may display the determined first character point 620 on a display.

The electronic device may display first auxiliary lines 631 and 632 at vertices of a region including the first character point 410. For example, the first auxiliary lines 631 and 632 may correspond to a portion or entirety of a diagonal line of a square region including the first character point 410.

For example, when the user selects the upper right vertex and the lower left vertex of the region including the first character point 410, the electronic device may display the first auxiliary lines 631 and 632 as in FIG. 6B.

As in FIG. 6C, the electronic device may display an auxiliary line 641 based on an input from the user. For example, the electronic device may determine whether an input line passes through the diagonal vertices of the region including the first character point 410, and the straightness of the input line. The electronic device may display the auxiliary line 641 on the display as in FIG. 4C, when the input line passes through the diagonal vertices of the region including the first character point 410 and the straightness of the input line satisfies a set criterion, the electronic device may display the auxiliary line 641 on the display as in FIG. 4C.

If the operations of FIGS. 6B and 6C are performed likewise based on the upper left/lower right vertices of the region including the first character point 410, the electronic device may determine a first auxiliary point 650 as in FIG. 6D. For example, the first auxiliary point 650 may be the intersection point of two diagonal lines of the region including the first character point 410.

When an input of selecting the first auxiliary point 650 is received from the user, the electronic device may display auxiliary lines 651 and 652 based on the first auxiliary point 650. The auxiliary line 651 may be a straight line parallel to the vertical axis of the first grid 310, and the auxiliary line 652 may be a straight line parallel to the horizontal axis of the first grid 310.

Similar to FIGS. 4B and 4C, the electronic device may determine whether an input line that is input from the user passes through the first auxiliary point 650, the straightness of the input line, and the verticality/horizontality of the input line. When the input line satisfies set criteria, the electronic device may display the auxiliary lines on the display as in FIG. 6E.

The electronic device may perform operations substantially the same as the operations shown in FIGS. 6B to 6E in the second grid 322. The electronic device may display a second auxiliary point 660 in a region of the second grid 322, corresponding to the region of the first grid 310 including a first character point 620.

The electronic device may display second auxiliary lines substantially the same as the first auxiliary lines 631 and 632 on vertices of the second grid 322. The electronic device may display diagonal lines in the region of the second grid 322 along an input line, and determine the intersection point of the diagonal lines to be the second auxiliary point 660. When the user selects the second auxiliary point 660, the electronic device may display the auxiliary lines, which are straight lines parallel to the horizontal axis/vertical axis of the second grid 322, similar to FIG. 6D. Similar to FIG. 6E, the electronic device may display input lines parallel to the horizontal axis/vertical axis about the second auxiliary point 660 based on inputs from the user as in FIG. 6F.

The second grid 321 and 332 displayed on the display of the electronic device may be displayed according to three-point perspective. Accordingly, the second grid 321 and 332 may be expressed as a plurality of regions divided by parallel horizontal and vertical axes, but in practice, may be expressed as a plurality of regions divided by horizontal and vertical axes with gradients. The second grid 321 and 332 may be a 3D grid. The auxiliary lines provided by the electronic device and/or the auxiliary lines input by the user may be perpendicular and/or parallel to the horizontal or vertical axes of the second grid 321 and 332, and may correspond to straight lines with gradients on the display of the electronic device.

Further, the second auxiliary lines shown in the second grid 322 of FIG. 6F may be expressed as straight lines with gradients on the display of the electronic device.

In FIG. 6F, the electronic device may display a second character point 670 in the second grid 322. For example, the electronic device may receive an input for selecting a second character point from the user, and display the second character point 670 when the position of the input from the user corresponds to the first character point 620 of the first grid 310. When the position of the input from the user is within a set distance from the position corresponding to the first character point 620 of the first grid 310 in the second grid 322, the electronic device may display the second character point 670 on the display.

As in FIG. 6G, the electronic device may display the character line 410 and first character points 621, 622, 623, and 624 determined based on the character line 410 in the first grid 310. By repeating the operations of FIGS. 6A to 6F, the electronic device may display second character points 671, 672, 673, and 674 in the second grid 322. The second character points 671, 672, 673, and 674 may correspond to the first character points 621, 622, 623, and 624, respectively.

The electronic device may display an input line that is input from the user along the second character points 671, 672, 673, and 674 in the second grid 322. For example, based on whether the input line passes through all of the second character points 671, 672, 673, and 674 and corresponds to the character line 410, the electronic device may display an input line 680 corresponding to the character line 410 on the display, as in FIG. 6H. When the input line does not pass through at least one of the second character points 671, 672, 673, and 674 or does not correspond to the character line 410, the electronic device may hide the input line from the display. When the input line corresponds to the character line 410, it may indicate that the input line matches the curve of the character line 410. The electronic device may determine whether the input line corresponds to the character line 410 based on the lengths, shapes, and curvatures of the input line and the character line 410.

FIGS. 6A to 6H are examples of displaying the perspective view of the drawing object 200 in the first grid 310, wherein in FIG. 6H, the electronic device displays the input line 680 corresponding to the character line 410 along the second character points 671, 672, 673, and 674 in the second grid 322. In the case of displaying the side view of the drawing object 200 in the first grid 310, the electronic device may display second character points in the second grid 321 and display an input line corresponding to the character lines, in the substantially same manner as in FIGS. 6A to 6H.

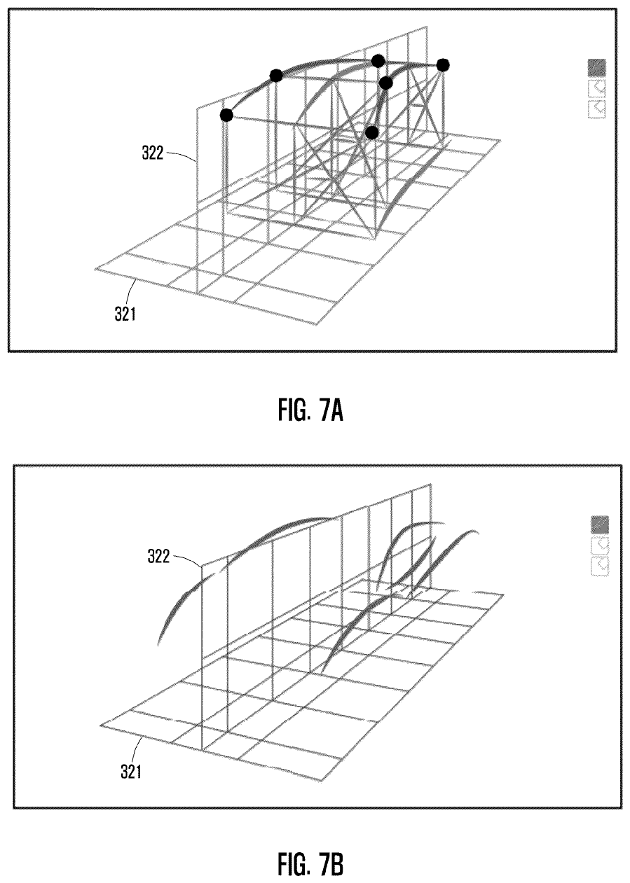

FIGS. 7A and 7B are diagrams illustrating an operation of providing auxiliary lines and auxiliary points by an electronic device according to various embodiments.

In FIGS. 5A to 6H, the electronic device may assist a user with inputting an input line corresponding to a character line by displaying auxiliary lines and/or auxiliary points. In FIGS. 5A to 6H, the input lines displayed in the second grid 321 and 332 may be the shape of the drawing object 200 observed in the side view and perspective view of the drawing object 200. The electronic device may determine third character points corresponding to the 3D shape of the drawing object 200 by providing auxiliary lines and/or auxiliary points, as in FIG. 7A. The user may input an input line along the third character points, and the electronic device may display the input line corresponding to the 3D shape of the drawing object 200 in the second grid 321 and 332, as in FIG. 7B.

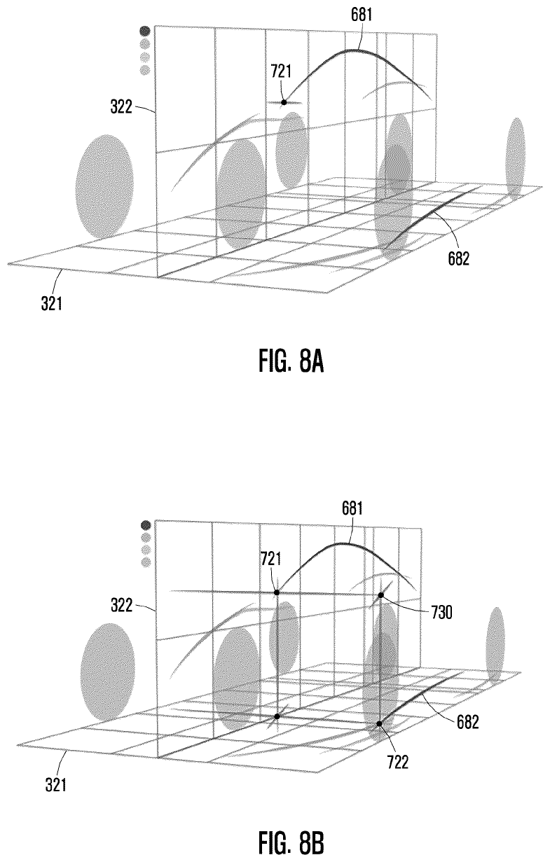

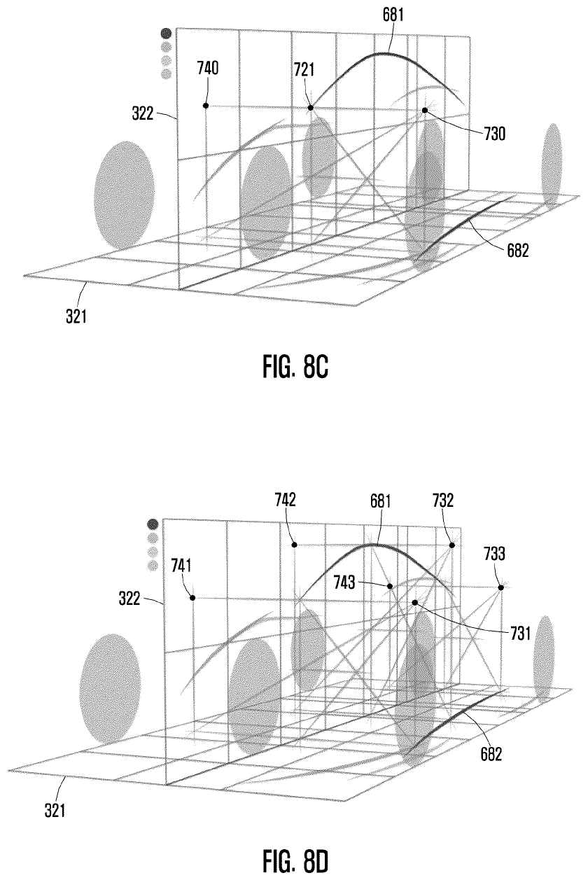

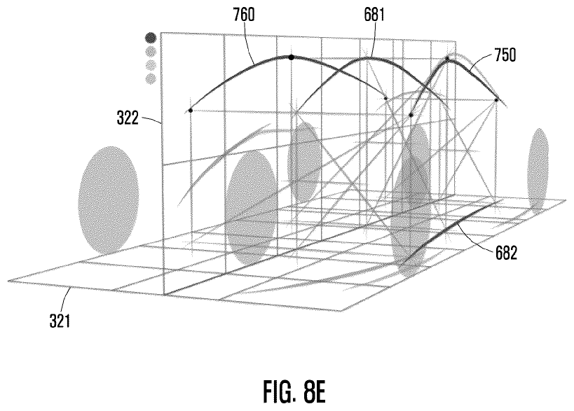

FIGS. 8A to 8E are diagrams illustrating an operation of providing auxiliary lines and auxiliary points by an electronic device according to various embodiments.

FIG. 8A shows an example of displaying an input line 681 corresponding to a character line in the second grid 322 and an input line 682 corresponding to a character line in the second grid 321. When a user selects a point 721 on the input line 681, auxiliary lines to determine third character points 730 and 740 may be displayed at the point 721.

In FIG. 8A, the user may draw a straight line parallel to the plane of the second grid 321 and a straight line perpendicular thereto along the auxiliary lines displayed at the point 721. The electronic device may display the point 721, the point at which a line perpendicular to the plane of the second grid 321 at the point 721 meets the second grid 321, a line perpendicular to the plane of the second grid 321 at a point 722, a line parallel thereto, and auxiliary lines to draw a diagonal line (e.g., the straight line between the point 721 and the point 722).

Since the second grid 321 and 332 are expressed according to three-point perspective, the straight line parallel to the plane of the second grid 321 and the straight line perpendicular thereto may be expressed as straight lines with gradients.

The electronic device may determine the point at which the line parallel to the plane of the second grid 321 at the point 721 meets the line perpendicular to the plane of the second grid 321 at the point 722 to be the third character point 730, as in FIG. 8B.

Further, the electronic device may determine the third character point 740 on the opposite side of the third character point 730, as in FIG. 8C. For example, the electronic device may determine a midpoint between the point 721 and the second grid 321, and determine a point at which a straight line passing through the midpoint and the point 730 meets the second grid 321. Using the determined point, the electronic device may determine the third character point 740.

As in FIG. 8D, the electronic device may provide third character points 731, 732, 733, 741, 742, and 743 corresponding to the 3D shape of the drawing object 200 based on the input lines 681 and 682.

The electronic device may determine whether input lines that are input from the user pass through the third character points 731, 732, and 733 and the third character points 741, 742, and 743, respectively, and whether the input lines correspond to the 3D shape of the drawing object. As in FIG. 8E, the electronic device may display an input line 750 when the input line passes through the third character points 731, 732, and 733 and corresponds to the 3D shape of the drawing object 200. As in FIG. 8E, the electronic device may display an input line 760 when the input line passes through the third character points 741, 742, and 743 and corresponds to the 3D shape of the drawing object 200.

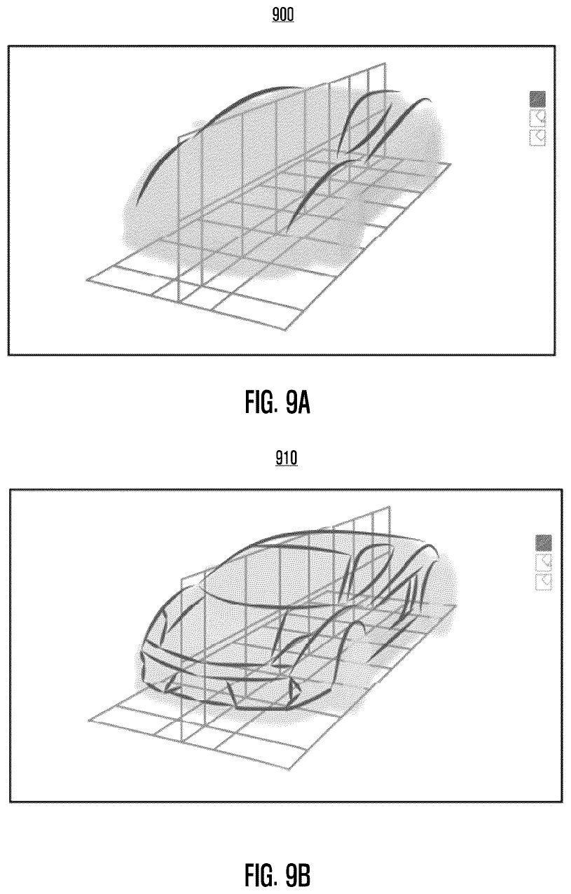

FIGS. 9A and 9B are diagrams illustrating an operation of displaying input lines in a drawing region in response to inputs from a user by an electronic device according to various embodiments and the electronic device according to various embodiments.

FIG. 9A shows an example of displaying input lines corresponding to the 3D shape of a drawing object through FIGS. 7A to 8E. The electronic device may display a drawing drawn by a user as in FIG. 9B, according to an input from the user in FIG. 9A.

The electronic device may display an auxiliary object to display the approximate shape, appearance, and features of the drawing object 200, as in FIGS. 9A and 9B. For example, as in FIGS. 9A and 9B, the electronic device may express a region corresponding to the shape of the drawing object 200 with a dark shade to help the user recognize the approximate shape of the drawing object 200.

In FIGS. 9A and 9B, the electronic device may hide a portion or entirety of an input line according to an input from the user. For example, the electronic device may operate in a mode of receiving an input line or a mode of deleting an input line according to an input from the user. In the mode of deleting an input line, the electronic device may delete a portion or entirety of an input line according to an input from the user, thereby hiding the deleted portion or entirety of the input line from the display.

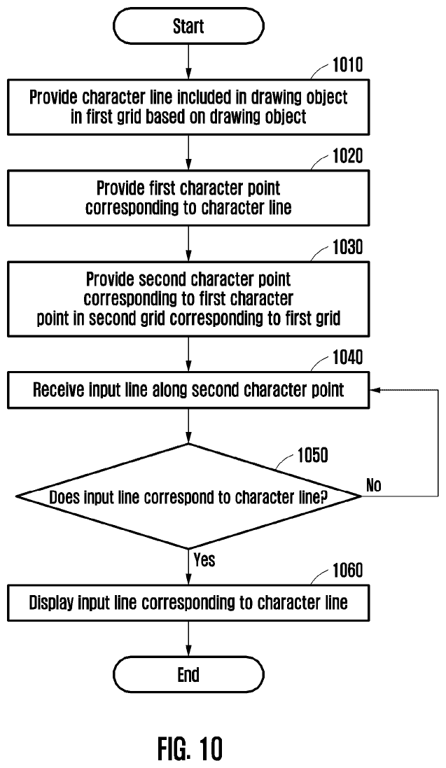

FIG. 10 is a flowchart illustrating a drawing method according to various embodiments.

Referring to FIG. 10, an electronic device according to various embodiments may provide a character line 410 included in a drawing object 200 in a first grid 310 based on the drawing object, in operation 1010.

Character lines 410 may be displayed in different colors. The electronic device may display a character line 410 selected according to an input from a user from among the character lines 410 displayed in different colors on a display.

The electronic device may provide a first character point 420 corresponding to the character line 410, in operation 1020. For example, when the user selects one point on the character line 410, the electronic device may display the selected point as the first character point 420 on the display.

The electronic device may provide a second character point 470 corresponding to the first character point 420 in a second grid 320 corresponding to the first grid 310, in operation 1030. For example, the electronic device may provide auxiliary lines and/or auxiliary points to provide the second character point 470 corresponding to the first character point 420 in the second grid 320.

The second character point 470 corresponding to the first character point 420 may be positioned in a region of the second grid 320 corresponding to a region including the first character point 420, among a plurality of regions of the first grid 310.

The electronic device may receive an input line along the second character point 470, in operation 1040.

The electronic device may determine whether the input line corresponds to the character line 410, in operation 1050. For example, when the input line passes through second character points and the length, shape, and curvature of the input line are similar to those of the character line 410 within set criteria, the electronic device may determine that the input line corresponds to the character line 410.

When the input line corresponds to the character line 410 in operation 1050, the electronic device may display the input line corresponding to the character line 410, in operation 1060. The electronic device may hide an input line not corresponding to the character line 410. After displaying the input line corresponding to the character line 410, the electronic device may hide the auxiliary lines and/or auxiliary points from the display.

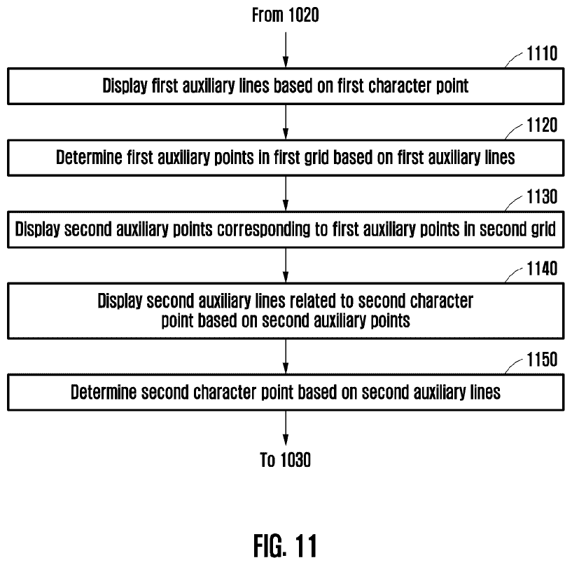

FIG. 11 is a flowchart illustrating an operation of determining a second character point by an electronic device according to various embodiments.

The electronic device may display first auxiliary lines 420-1 and 420-2 based on the first character point 420, in operation 1110. For example, the first auxiliary lines 420-1 and 420-2 may be straight lines parallel to the horizontal axis/vertical axis of the first grid 310 at the first character point 420.

The electronic device may determine first auxiliary points 441 and 442 in the first grid 310 based on the first auxiliary lines 420-1 and 420-2, in operation 1120. For example, the electronic device may display auxiliary lines 431 and 432 according to an input from the user. The electronic device may determine the points where the auxiliary lines 431 and 432 and the first grid 310 meet to be the first auxiliary points 441 and 442.

The electronic device may display second auxiliary points 451 and 452 corresponding to the first auxiliary points 441 and 442 in the second grid 320, in operation 1130. For example, the electronic device may display the second auxiliary points 451 and 452 on the boundary of the region of the second grid 320 corresponding to the region including the first character point 420 of the first grid 310. The electronic device may display the second auxiliary points 451 and 452 in the second grid 320, according to an input from the user.

The electronic device may display second auxiliary lines related to the second character point 470 based on the second auxiliary points 451 and 452, in operation 1140. For example, when the user selects the second auxiliary points 451 and 452, the electronic device may display auxiliary lines at the second auxiliary points 451 and 452. The user may input a line along the second auxiliary points 451 and 452. When a line input along the second auxiliary points 451 and 452 passes through the second auxiliary points 451 and 452 and satisfies set criteria (e.g., the straightness and the degree of being parallel to the horizontal axis/vertical axis of the second grid 320), the electronic device may display the input line.

The electronic device may determine the second character point 470 based on the second auxiliary lines, in operation 1150. When the user inputs lines along the auxiliary lines displayed at the second auxiliary points 451 and 452, the electronic device may determine the intersection point of the input lines to be the second character point 470.

For example, when an input from the user is received at the intersection point of the lines, the electronic device may determine the intersection point of the lines to be the second character point 470.

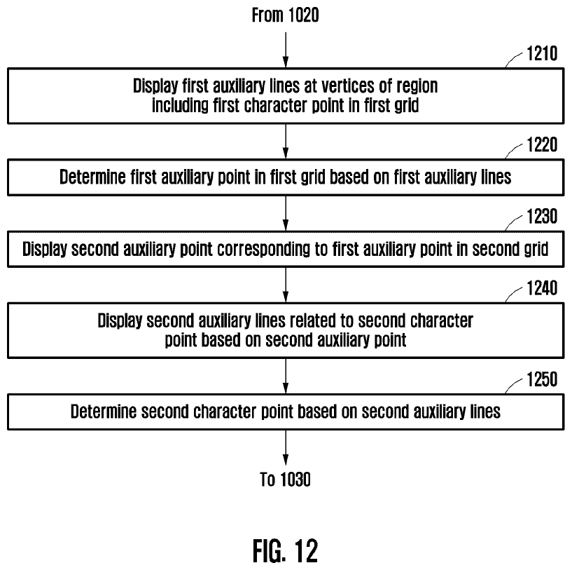

FIG. 12 is a flowchart illustrating an operation of determining a second character point 670 by an electronic device according to various embodiments.

The electronic device may display first auxiliary lines 631 and 632 at vertices of a region including the first character point 420 in the first grid 310, in operation 1210. The user may input a diagonal line in the region of the first grid 310 along the first auxiliary lines 631 and 632.

For example, when the character line 410 is displayed in the first grid 310, the electronic device may display the first auxiliary lines 631 and 632 at the vertices of the region including the first character point 420 in the first grid 310.

For example, the electronic device may display an input line 480 corresponding to the character line in the first grid 310, in operation 1210. The electronic device may display the first auxiliary lines 631 and 632 at the vertices of the region including the character point (e.g., the second character point 470 of FIG. 4D) of the input line 480 corresponding to the character line in the first grid 310.

The electronic device may determine a first auxiliary point 650 in the first grid 310 based on the first auxiliary lines 631 and 632, in operation 1120. The electronic device may display auxiliary lines 651 and 652 at the first auxiliary point 650, and receive a line input from the user according to the auxiliary lines 651 and 652. The electronic device may display the input line when the input line passes through the auxiliary point 650 and satisfies set criteria (the degree of being parallel to the horizonal axis/vertical axis of the first grid 310 and the straightness).

The electronic device may display a second auxiliary point 660 corresponding to the first auxiliary point 650 in the second grid 321 and 332, in operation 1230. For example, by performing the operation of determining the first auxiliary point 650 in the first grid 310 identically with respect to the second grid 321 and 332, the electronic device may determine the second auxiliary point 660.

The electronic device may display auxiliary lines related to the second character point 670 based on the second auxiliary point 660, in operation 1240.

The electronic device may determine a second character point 670 based on the second auxiliary lines, in operation 1250. For example, the electronic device may determine the position of the second character point 670 with respect to the auxiliary lines of the second grid 321 and 332, using the relative position of a first character point 620 with respect to the auxiliary lines of the first grid 310. When the user selects a position within a set distance from the determined position of the second character point 670, the electronic device may display the second character point 670 at the selected position.\

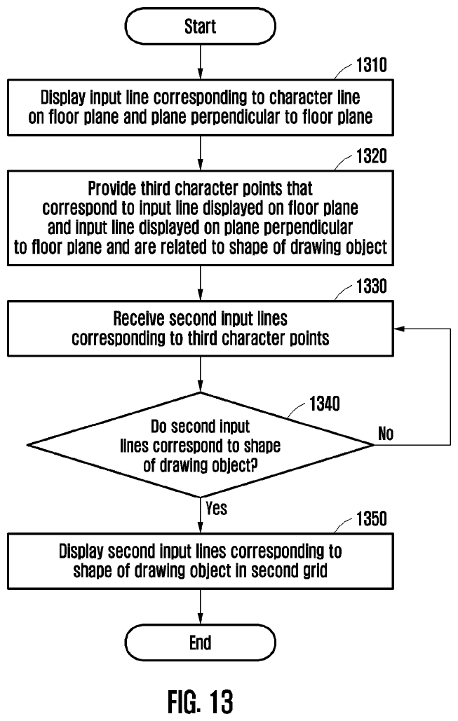

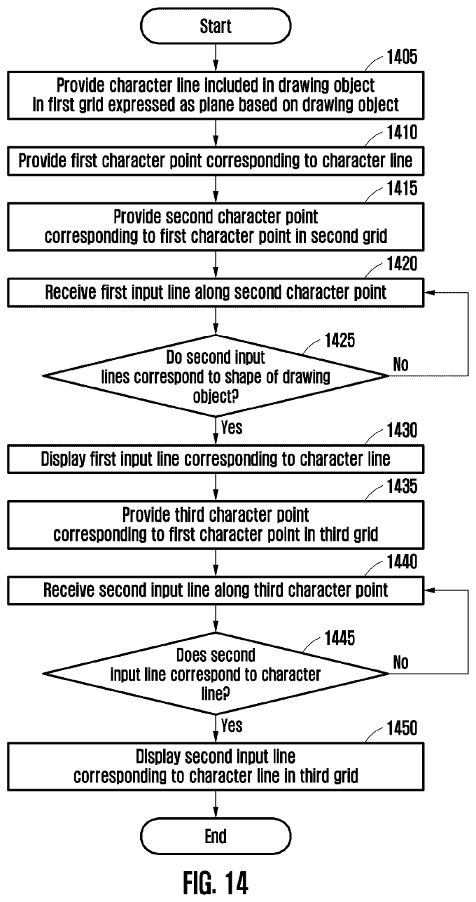

FIG. 13 is a flowchart illustrating an operation of displaying second input lines in a second grid by an electronic device according to various embodiments.

The electronic device may display the input line corresponding to the character line 410 on a floor plane and a plane perpendicular to the floor plane, in operation 1310. The second grid 321 may correspond to the floor plane in a 3D coordinate system, and the second grid 322 may correspond to the plane perpendicular to the floor plane in the 3D coordinate system.

The electronic device may provide third character points 730 and 740 that correspond to an input line displayed on the floor plane and an input line displayed on the plane perpendicular to the floor plane and are related to the shape of the drawing object 200, in operation 1320. The electronic device may provide auxiliary points and/or auxiliary lines to determine the third character points 730 and 740, as in FIGS. 8A to 8E.

The electronic device may receive second input lines along the third character points 730 and 740, in operation 1330.

The electronic device may determine whether the second input lines correspond to the shape of the drawing object 200, in operation 1340. The electronic device may determine whether the second input lines pass through the third character points 730 and 740.

When the second input lines correspond to the shape of the drawing object 200 in operation 1340, the electronic device may display second input lines 750 and 760 corresponding to the shape of the drawing object 200 in the second grid 321 and 332. The electronic device may display the second input lines 750 and 760 corresponding to the shape of the drawing object 200 on the display.

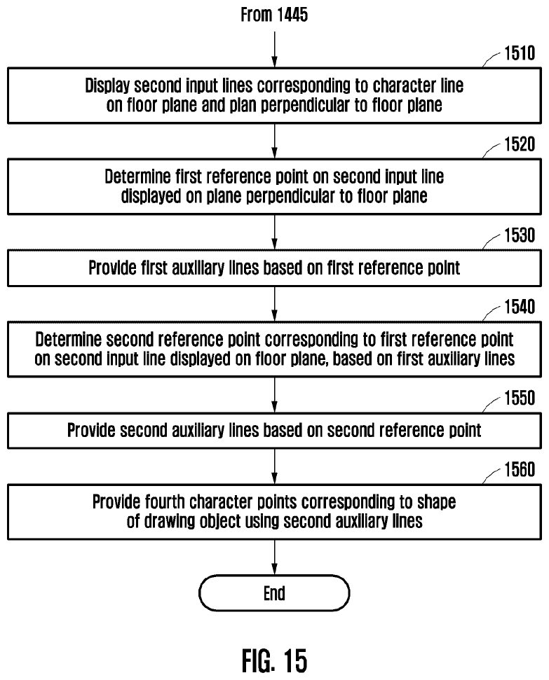

FIG. 14 is a flowchart illustrating a drawing method according to various embodiments.

The electronic device may provide the character line 410 included in the drawing object 200 in the first grid 310 expressed as a plane, based on the drawing object 1405, in operation 1405.

The electronic device may provide the first character point 420 corresponding to the character line 410, in operation 1410. For example, the electronic device may display one point on the character line 410 as the first character point 420 on the display, according to a selection by the user.

The electronic device may provide the second character point 470 corresponding to the first character point 420 in the second grid 320, in operation 1415. The electronic device may display auxiliary lines and/or auxiliary points for assistance in determining the second character point 470 in the first grid 310 and/or the second grid 320. When the second character point 470 corresponding to the first character point 420 is displayed on the display, the electronic device may hide, from the display, the lines and/or points (e.g., the first auxiliary lines 420-1 and 420-2, the auxiliary lines 431 and 432, the first auxiliary points 441 and 442, the second auxiliary points 451 and 452, and the auxiliary lines 461 and 462 of FIGS. 4A to 4F) displayed on the display to assist with determining the second character point 470.

The electronic device may receive a first input line along the second character point 470, in operation 1420.

The electronic device may determine whether the first input line corresponds to the character line 410, in operation 1425. The electronic device may determine whether the first input line corresponds to the character line 410 based on whether the first input line passes through the second character points and the length, shape, and curvature of the input line.

The electronic device may display the first input line 480 corresponding to the character line 410, in operation 1430. When the first input line 480 corresponding to the character line 410 is displayed on the display, the electronic device may hide, from the display, the lines and/or points (e.g., the first character points 421, 422, 423, 424, and 425, and the second character points 471, 472, 473, 474, and 475 of FIGS. 4A to 4F) for assistance in drawing the first input line 480 corresponding to the character line 410.

The electronic device may provide a third character point 670 corresponding to the first character point 420 in a third grid 321 and 322, in operation 1435. The third grid 321 and 322 may include a floor plane and a plane perpendicular to the floor plane in a 3D coordinate system. The electronic device may provide lines and/or points for assistance in determining the third character point 670. When the third character point 670 is displayed on the display, the electronic device may hide the lines and/or points for assistance in determining the third character point 670 from the display.

The electronic device may receive a second input line along the third character point 670, in operation 1440.

The electronic device may determine whether the second input line corresponds to the character line 410, in operation 1445. The electronic device may determine whether the second input line corresponds to the character line 410 based on whether the second input line passes through the third character point, and the length, shape, and curvature of the second input line.

The electronic device may display a second input line 680 corresponding to the character line 410 in the third grid 321 and 322, in operation 1450. The electronic device may display the second input line 680 corresponding to the character line 410 on the display, in operation 1450. The electronic device may display the second input line 680 corresponding to the character line 410 on the display and then, hide the points and/or lines for assistance in drawing the second input line 680 corresponding to the character line 410 from the display.

FIG. 15 is a flowchart illustrating an operation of providing fourth character points 730 and 740 by an electronic device according to various embodiments.

The electronic device may display second input lines 681 and 682 corresponding to the character line 410 on the floor plane and the plan perpendicular to the floor plane, in operation 1510.

The electronic device may determine a first reference point 721 on the second input line 681 displayed on the plane perpendicular to the floor plane, in operation 1520. The electronic device may determine the point selected on the second input line 681 to be the first reference point 721 based on an input from the user.

The electronic device may provide first auxiliary lines based on the first reference point 721, in operation 1530. For example, the electronic device may provide an auxiliary line perpendicular to the third grid 321 on the floor plane at the first reference point 721, and an auxiliary line perpendicular to the third grid 322 perpendicular to the floor plane at the first reference point 721.

The electronic device may determine a second reference point 722 corresponding to the first reference point 721 on the second input line 682 displayed on the floor plane, based on the first auxiliary lines, in operation 1540. For example, the electronic device may determine the point at which the line perpendicular to the third grid 322 at the first reference point 721 meets the third greed 322, and determine the point at which the line perpendicular to the third grid 321 at the corresponding point meets the second input line 682 to be the second reference point 722.

The electronic device may provide second auxiliary lines based on the second reference point 722, in operation 1550. For example, the electronic device may provide auxiliary lines perpendicular to the third grid 321 at the second reference point 722.

The electronic device may provide the third character points 730 and 740 corresponding to the shape of the drawing object 200 using the second auxiliary lines, in operation 1560. For example, the electronic device may determine the point at which the straight line perpendicular to the third grid 321 at the second reference point 722 meets the straight line perpendicular to the third grid 322 at the first reference point 721 to be the fourth character point 730. For example, the electronic device may determine the point in symmetry with the fourth character point 730 with respect to the third grid 322 using the second auxiliary lines, and determine the corresponding point to be the fourth character point 740.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, can be made.

1. A drawing method comprising:
providing a character line included in a drawing object in a first grid based on the drawing object;
providing a first character point corresponding to the character line;
providing a second character point corresponding to the first character point in a second grid corresponding to the first grid;
receiving an input line along the second character point; and
determining whether the input line corresponds to the character line.

2. The drawing method of claim 1, wherein
the providing of the second character point comprises:
displaying first auxiliary lines based on the first character point;
determining first auxiliary points in the first grid based on the first auxiliary lines;
displaying second auxiliary points corresponding to the first auxiliary points in the second grid;
displaying second auxiliary lines related to the second character point based on the second auxiliary points; and
determining the second character point based on the second auxiliary lines.

3. The drawing method of claim 1, wherein
the providing of the second character point comprises:
displaying first auxiliary lines at vertices of a region comprising the first character point in the first grid;
determining a first auxiliary point in the first grid based on the first auxiliary lines;
displaying a second auxiliary point corresponding to the first auxiliary point in the second grid; and
displaying second auxiliary lines related to the second character point based on the second auxiliary point.

4. The drawing method of claim 1, wherein
the first grid is displayed on a plane, and
the second grid is displayed on a floor plane and a plane perpendicular to the floor plane in a three-dimensional coordinate system.

5. The drawing method of claim 4, wherein
the providing of the second character point comprises:
displaying, on the floor plane, a second character point corresponding to a first character point that is based on a perspective view of the drawing object; and
displaying, on the plane perpendicular to the floor plane, a second character point corresponding to a first character point that is based on a side view of the drawing object.

6. The drawing method of claim 5, further comprising:
displaying the input line corresponding to the character line on the floor plane and the plane perpendicular to the floor plane; and
providing third character points that correspond to the input line displayed on the floor plane and the input line displayed on the plane perpendicular to the floor plane and are related to a shape of the drawing object.

7. The drawing method of claim 1, wherein
the providing of the character line comprises providing a first character line that is based on a perspective view of the drawing object and a second character line that is based on a side view of the drawing object, and
the first character line and the second character line correspond to a shape of the drawing object.

8. The drawing method of claim 1, further comprising:
displaying the input line corresponding to the character line when the input line corresponds to the character line.

9. The drawing method of claim 2, wherein
the determining of the first auxiliary points comprises displaying a second input line corresponding to the first auxiliary lines based on a straightness of the second input line, a gradient of the second input line, and whether the second input line passes through the first character point, and
the determining of the second character point comprises displaying a third input line corresponding to the second auxiliary lines based on a straightness of the third input line, a gradient of the third input line, and whether the third input line passes through the second auxiliary points.

10. A drawing method comprising:
providing a character line included in a drawing object in a first grid displayed as a plane based on the drawing object;
providing a first character point corresponding to the character line;
providing a second character point corresponding to the first character point in a second grid;
receiving a first input line along the second character point;
determining whether the first input line corresponds to the character line;
providing a third character point corresponding to the second character point in a third grid;
receiving a second input line along the third character point; and
determining whether the second input line corresponds to the character line,
wherein the second grid is displayed as a plane corresponding to the first grid, and
the third grid is displayed on a floor plane and a plane perpendicular to the floor plane of a three-dimensional coordinate system corresponding to the first grid.

11. The drawing method of claim 10, wherein
the providing of the second character point comprises:
displaying first auxiliary lines based on the first character point;
determining first auxiliary points in the first grid based on the first auxiliary lines;
displaying second auxiliary points corresponding to the first auxiliary points in the second grid; and
displaying second auxiliary lines related to the second character point based on the second auxiliary points.

12. The drawing method of claim 10, wherein
the providing of the third character point comprises:
displaying a first input line corresponding to the character line in the first grid;
displaying first auxiliary lines at vertices of a region comprising the second character point in the first grid;
determining a first auxiliary point in the first grid based on the first auxiliary lines;
displaying a second auxiliary point corresponding to the first auxiliary point in the third grid; and
displaying second auxiliary lines related to the third character point based on the second auxiliary point.

13. The drawing method of claim 10, further comprising:
displaying second input lines corresponding to the character line on the floor plane and the plane perpendicular to the floor plane;
determining a first reference point on the second input line displayed on the plane perpendicular to the floor plane;
providing first auxiliary lines based on the first reference point;
determining a second reference point corresponding to the first reference point on the second input line displayed on the floor plane using the first auxiliary lines;
providing second auxiliary lines based on the second reference point; and
providing a fourth character point corresponding to a shape of the drawing object using the second auxiliary lines.

14. The drawing method of claim 13, further comprising:
determining whether a third input line received along the fourth character point corresponds to the shape of the drawing object; and
displaying the third input line corresponding to the shape of the drawing object and a shade corresponding to the shape of the drawing object in the third grid.

15. An electronic device comprising:
a processor,
wherein the processor is configured to:
provide a character line included in a drawing object in a first grid based on the drawing object,
provide a first character point corresponding to the character line,
provide a second character point corresponding to the first character point in a second grid corresponding to the first grid,
receive an input line along the second character point, and
determine whether the input line corresponds to the character line.

16. The electronic device of claim 15, wherein
the processor is configured to:
display first auxiliary lines based on the first character point,
determine first auxiliary points in the first grid based on the first auxiliary lines, display second auxiliary points corresponding to the first auxiliary points in the second grid, and
display second auxiliary lines related to the second character point based on the second auxiliary points.

17. The electronic device of claim 15, wherein
the processor is configured to:
display first auxiliary lines at vertices of a region comprising the first character point in the first grid,
determine a first auxiliary point in the first grid based on the first auxiliary lines, display a second auxiliary point corresponding to the first auxiliary point in the second grid, and
display second auxiliary lines related to the second character point based on the second auxiliary point.

18. The electronic device of claim 15, wherein
the first grid is displayed on a plane, and
the second grid is displayed on a floor plane and a plane perpendicular to the floor plane in a three-dimensional coordinate system.

19. The electronic device of claim 18, wherein
the processor is configured to:
display, on the floor plane, a second character point corresponding to a first character point that is based on a perspective view of the drawing object, and
display, on the plane perpendicular to the floor plane, a second character point corresponding to a first character point that is based on a side view of the drawing object.

20. The electronic device of claim 19, wherein
the processor is configured to:
display the input line corresponding to the character line on the floor plane and the plane perpendicular to the floor plane, and
provide third character points that correspond to the input line displayed on the floor plane and the input line displayed on the plane perpendicular to the floor plane and are related to a shape of the drawing object.
